(19) United States
(12) Patent Application Publication
(10) Pub. No.: US 2023/0184050 A1
(43) Pub. Date: Jun. 15, 2023

(54) BIDIRECTIONAL PRESSURE-INTENSIFIED SEAL

(71) Applicant: SPM Oil & Gas PC LLC, Fort Worth, TX (US)

(72) Inventors: David Hugh NASH, Prestwick, Scotland (GB); Yevgen GORASH, Glasgow (GB); Ali Ahmed ANWAR, Blanefield (GB); Michael L. MANN, Bulverde, TX (US)

(73) Assignee: SPM Oil & Gas PC LLC, Fort Worth, TX (US)

(21) Appl. No.: 17/926,491

(22) PCT Filed: May 21, 2021
(86) PCT No.: PCT/US2021/033737

§ 371 Date: Nov. 18, 2022

Related U.S. Application Data
(60) Provisional application No. 63/029,213, filed on May 22, 2020.

(51) Int. Cl. E21B 33/12; F16L 17/025; F16J 15/10; F16J 15/08; F16J 15/06

(52) U.S. Cl. CPC E21B 33/1208; F16J 15/068; F16J 15/102; F16J 15/0806; F16L 17/025

(57) ABSTRACT

A pressure-energized bidirectional seal having a main body having a first end and a second end and a pair of legs extending from the second end of the main body, the pair of legs having an inner surface and an outer surface, the inner surface forming a hollow interior opening in a first direction. The bidirectional seal includes at least one rib extending from the outer surfaces and configured to sealingly engage a mating surface of a mating body the at least one rib forming a sealing zone opening in a second direction opposite of the first direction.

### CROSS REFERENCE TO RELATED APPLICATIONS

This application claims the benefit of and priority to co-pending U.S. Provisional Pat. Application No. 63/029,213, filed May 22, 2020, entitled “Bidirectional Pressure-Intensified Seal,” the disclosure of which is hereby incorporated herein by reference in its entirety.

### FIELD

This disclosure relates in general to high-pressure seals.

### BACKGROUND

In oilfield applications, it is common to use pressure seals to isolate sections of the wellbore, such as the annular spaces in between the pipe strings running downhole, inner bodies such as tubing hangers, or pack-offs positioned inside of outer bodies. Seals allow the wellbore operators to control flow of materials out of, or into, the well.

A common seal design in oilfield applications has a U-shaped cross-section. These seals are placed into position such that the legs of the seal face into the high-pressure zone. So positioned, the ends of the legs press against a mating surface and create a seal point. As the pressure inside the sealed section increases, the legs of the seal are pressed against the mating surface with increasing force. Thus as the contained pressure increases, the seal is further energized. This aspect of the mechanical design of the seal, called pressure-intensified sealing, allows the seals to withstand extreme pressures, upward of 20,000 psi.

The U-shaped seals provide excellent sealing effect in one direction, and thus are commonly called unidirectional seals. In order to provide bidirectional sealing, two U-shaped seals may be abutted to form a seal with an H-shaped cross-section. An H-shaped profile seal can be used to seal pressure using the pressure intensification effects from both directions where each U-shaped profile of the “H” faces a direction from which pressure can energize the seal and create a sealing effect between the seal and a mating body. To create this bidirectional sealing capability, two unidirectional seals are required to be stacked and oppose each other, or a taller, single-piece body can be used. Typical bidirectional seals are more expensive and require much more space within the string than a unidirectional seal.

Additional seals commonly used in the oil and gas industry include cross-sectional geometry that is generally rectangular or circular in nature, where two bodies, one above and one below, are mechanically forced against the seal and an interference between the sealing edges and mating bodies creates a contact stress which forms a pressure boundary. These seals provide a bidirectional seal, but are bulky and expensive. The disclosed seal design provides bidirectional sealing capability in the same height as a unidirectional design, resulting in lower costs and system complexity.

Mechanically-energized seals and pressure-energized seals fail over time. The failure is often caused by a loss of sufficient contact between the mating surfaces due to loose fabrication dimensions or degradation over time brought on by differences in the thermal expansion properties of the mating materials, which changes contact stresses between the seal and mating bodies such that the contact stresses become insufficient and are no longer capable of maintaining or controlling the pressurized fluid mediums.

Seals also fail due to repeated stress loading and unloading cycles. The current U-shaped or H-shaped seal designs are subject to high levels of plastic stress in the legs of the seals. After repeated stress loading and unloading cycles brought on by, for example, pressure fluctuations in the wellbore during operation, the legs of the seals oftentimes mechanically fail.

It was desirable then to create a new bidirectional seal design that would have similar space requirements as a unidirectional seal and that would be less failure prone than current bidirectional seal designs.

### SUMMARY

According to a first aspect, there is provided a pressure-energized bidirectional seal having a main body having a first end and a second end and a pair of legs extending from the second end. The pair of legs includes an inner surface and an outer surface, the inner surface forming a hollow interior formed in a first direction. The seal further includes at least one rib extending from the outer surfaces forming a sealing zone opening in a second and opposite direction from the first direction,. The at least one rib is configured to sealingly engage a mating surface of a mating body.

In some embodiments, the at least one rib extends toward the first end.

In still other embodiments, the at least one rib is formed having a tip to sealingly engage the mating surface, the tip having a planar surface.

In yet other embodiments, the at least one rib comprises three spaced apart ribs extending from the outer surfaces to sealingly engage the mating surface.

In other embodiments, the three spaced apart ribs form spaced apart sealing zones therebetween opening in the second direction.

In still another embodiment, the seal is formed of a non-metallic material.

In other embodiments, the seal is formed of a polytetrafluoroethylene-based (PTFE) material, a polyether ether ketone-based (PEEK) material, or an elastic polymer material.

In yet other embodiments, the seal is formed of nickel-copper alloys, carbon steels, stainless steels, chromium steels, high-nickel chromium steels, nickel-chromium alloys, nickel-molybdenum-chromium alloys, nickel-chromium-cobalt alloys, cobalt-chromium-nickel alloys, cobalt-nickel-chromium-tungsten alloys, nickel-chromium-tungsten-molybdenum alloys, nickel-chromium-aluminum-iron alloys, or nickel-chromium-cobalt alloys.

In some embodiments, the main body of the seal is formed of a first material and the legs are formed of a second and different material.

In still other embodiments, the main body and legs are formed of a first material and the plurality of ribs are formed of a second material.

In yet another embodiment, the at least one rib includes three spaced apart ribs extending from the outer surfaces to sealingly engage the mating surface, at least one of the ribs formed of a material different from the other ribs.

In yet another embodiment, a coating covers at least a portion of the at least one rib.

According to a second aspect, there is provided a bidirectional pressure-energized seal having a main body formed having a first upper surface and an opposed bottom second surface, an inner and an outer sidewall extending between the first and second surfaces. The seal also includes an inner leg and an outer leg extending from the second surface, the inner and outer legs having an outer surface and an inner surface, the inner surfaces forming a hollow interior opening in a first direction. A plurality of spaced apart ribs extend from the outer leg outer surface and are sized to sealingly engage a surface of a mating body. At least one of the plurality of ribs angularly extends toward the upper surface of the main body and forming a sealing zone opening in a second direction generally opposite to the first direction.

In one embodiment, the bidirectional pressure-energized seal is formed of a polytetrafluoroethylene-based (PTFE) material, a polyether ether ketone-based (PEEK) material, or an elastic polymer material.

In other embodiments, the bidirectional pressure-energized seal is formed of nickel-copper alloys, carbon steels, stainless steels, chromium steels, high-nickel chromium steels, nickel-chromium alloys, nickel-molybdenum-chromium alloys, nickel-chromium-cobalt alloys, cobalt-chromium-nickel alloys, cobalt-nickel-chromium-tungsten alloys, nickel-chromium-tungsten-molybdenum alloys, nickel-chromium-aluminum-iron alloys, or nickel-chromium-cobalt alloys.

In still other embodiments, the plurality of ribs are formed having a planar end surface to sealingly engage the mating surface.

In yet another embodiment, the plurality of ribs includes three ribs.

In another embodiment, a coating is disposed over the plurality of ribs.

In still another embodiment, each rib of the plurality of ribs is of a constant thickness.

According to a third aspect, there is provided a method of installing a bidirectional pressure-energized seal. The method includes providing a bi-directional pressure-energized seal having a main body having a first upper surface and a second lower surface and a pair of legs extending from the second surface of the main body. The legs have an inner surface and an outer surface, the inner surface forms a hollow interior opening in a first direction, and further include a plurality ribs extending from the outer surface in a direction toward the first upper surface, the plurality of ribs forming sealing zones opening in a second direction generally opposite the first direction. The method includes providing a fluid conduit with an outer surface, providing a valve, the valve being configured to receive a portion of the fluid conduit and having a mating surface for engaging a seal. The method also includes seating the bidirectional seal on the outer surface of the fluid conduit and inserting a portion of the fluid conduit into the valve such that the bidirectional seal sealingly engages the mating surface of the valve.

Other aspects, features, and advantages will become apparent from the following detailed description when taken in conjunction with the accompanying drawings, which are a part of this disclosure and which illustrate, by way of example, principles of the disclosed invention.

### DESCRIPTION OF THE FIGURES

The accompanying drawings facilitate an understanding of the various embodiments.

FIG. 1 is an isometric view of a bidirectional seal.

FIG. 2 is a detail isometric view of the bidirectional seal of FIG. 1.

FIG. 3 is an isometric view of the bidirectional seal of FIGS. 1 and 2 sealingly engaging a mating body.

FIG. 4 is a detail cross section view of a portion of the bidirectional seal engaging a mating body.

FIG. 5 is a cross section view of a bidirectional seal against a mating body showing the ribs contacting the mating body and showing the results of a finite element simulation run to predict the plastic strain present in the body.

FIG. 6 is another detail cross section view of a bidirectional seal against a mating body showing the detail of the ribs contacting the mating body and showing the results of a finite element simulation run to predict the plastic strain present in the body.

FIG. 7 is a cross section view of a unidirectional seal against a mating body showing the results of a finite element simulation run to predict the plastic strain present in the body of the seal.

FIG. 8 is a graph showing the contact pressure vs. the contact length for a unidirectional seal design as calculated in a simulation of the installation of the seal, two high pressure cycles, and two low pressure cycles.

FIG. 9 is a graph showing the contact pressure vs. the contact length for the lower rib of the bidirectional seal design as calculated in a simulation of the installation of the seal, two high pressure cycles, and two low pressure cycles.

FIG. 10 is a graph showing the contact pressure vs. the contact length for an intermediate rib of the bidirectional seal design as calculated in a simulation of the installation of the seal, two high pressure cycles, and two low pressure cycles.

FIG. 11 is a graph showing the contact pressure vs. the contact length for the upper rib of the bidirectional seal design as calculated in a simulation of a high pressure cycle and a low pressure cycle.

FIG. 12 is a graph showing the average pressure and sealing efficiency of a unidirectional seal design as calculated in a simulation of the installation of the seal, two high pressure cycles, and two low pressure cycles.

FIG. 13 is a graph showing the average pressure and sealing efficiency of lower rib of the bidirectional seal design as calculated in a simulation of the installation of the seal, two high pressure cycles, and two low pressure cycles.

FIG. 14 is a graph showing the average pressure and sealing efficiency of intermediate rib of the bidirectional seal design as calculated in a simulation of the installation of the seal, two high pressure cycles, and two low pressure cycles.

FIG. 15 is a graph showing the average pressure and sealing efficiency the upper rib of the bidirectional seal design as calculated in a simulation of a high pressure cycle and a low pressure cycle.

FIG. 16 is a plot showing the distribution of the contact pressure of a unidirectional seal design as calculated by a simulation of a seal under high pressure conditions.

FIG. 17 is a plot showing the distribution of the contact pressure of the bidirectional seal design as calculated by a simulation of a seal under high pressure conditions.

FIG. 18 is a plot showing the distribution of the contact pressure of a unidirectional seal design as calculated by a simulation of a seal under low pressure conditions.

FIG. 19 is a plot showing the distribution of the contact pressure of the bidirectional seal design as calculated by a simulation of a seal under low pressure conditions.

Like numerals refer to like elements.

### DETAILED DESCRIPTION

Seals are used to isolate volumes from each other. In the context of an oil or gas well, seals are used to isolate sections of the wellbore and tubing string from each other and to control the flow of fluids and other materials. Seals may be unidirectional or bidirectional in nature. A unidirectional seal resists pressure in one direction while a bidirectional seal resists pressure in two directions.

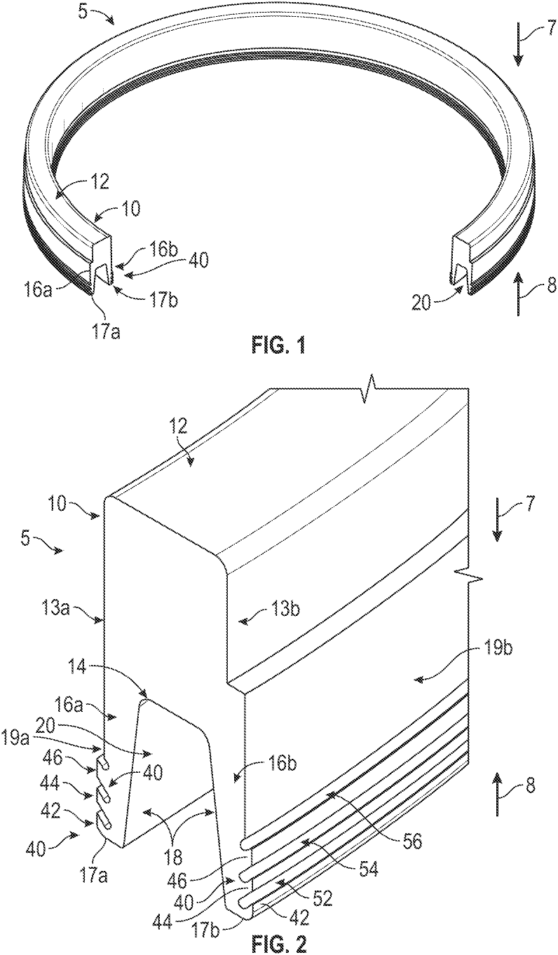

FIGS. 1 and 2 illustrate an isometric and a detail isometric view, respectively, of a bidirectional, pressure-intensified seal 5. In the embodiment illustrated in FIGS. 1 and 2, the seal 5 is formed with a main body 10 having a first/upper surface end 12, an opposed second/lower surface end 14, and inner and outer sidewalls 13a and 13b extending between the first and second surfaces 12 and 14, the main body 10 having a generally rectangular cross sectional area and arcuately extending along its length, as seen specifically in FIG. 1. It should be understood that while the main body 10 is illustrated having a generally rectangular cross sectional area, other shapes and sizes may be utilized (i.e., square, circular, oval, etc.). In the embodiment illustrated in FIGS. 1 and 2, a pair of legs 16a and 16b extend from the second end 14 of the main body 10 and are spaced apart to form a hollow interior 20. As illustrated in FIG. 2, the legs 16a and 16b include an inner surface 18 forming a boundary of the hollow interior 20 and outer surfaces 19a and 19b that sealingly engage a mating surface when, as discussed in greater detail below, the seal 5 is energized. In the embodiment illustrated in FIGS. 1 and 2, the legs 16a and 16b flare outwardly as they extend from the main body 10 such that the outer diameter of the seal 5 is greatest at the ends 17a and 17b of respective legs 16a and 16b compared to the outer diameter of at the second end of the main body 10.

As illustrated in the embodiment illustrated in FIG. 2, the hollow interior 20 opens in a primary or first seal direction as illustrated by arrow 7, which is a direction opposite a secondary seal direction, as illustrated by arrow 8. As explained in greater detail below, the hollow interior 20 opens into and otherwise faces a high pressure side 6 of a fluid passageway.

Referring specifically to FIG. 2, a plurality of ribs 40 are formed in the outer surfaces 19a and 19b generally extend in the direction of arrow 8 toward the first end 12. In the embodiment illustrated in FIGS. 1 and 2, three ribs 40 are shown, namely, a lower rib 42, an intermediate rib 44, and an upper rib 46, however, it should be understood that a greater or fewer number of ribs 40 may be used depending on the specific application. For example, in some embodiments, five ribs 40 are used, including a lower rib 42, three intermediate ribs 44, and an upper rib 46. Other embodiments, for example, may only incorporate two ribs 40, such as a lower rib 42 and an upper rib 46. According to some embodiments, the ribs 40 are angularly disposed relative to a horizontal axis by about 30 degrees; however, it should be understood that a larger angle (i.e., greater than 30 degrees from the horizontal) or a smaller angle (i.e., less than 30 degrees from the horizontal) can be used. Furthermore, while the embodiment illustrated in FIGS. 1 and 2 illustrate the ribs 40 extending in parallel relationship to each other, each rib may be otherwise angled. For example, rib 42 may be oriented at an angle less than the angle of rib 44. Likewise, rib 46 may the angled the same or different from the angles of the other ribs 42 or 44.

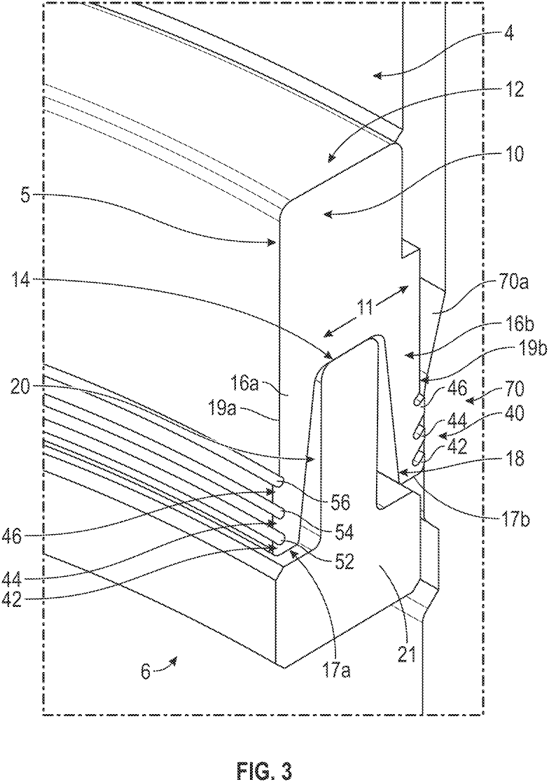

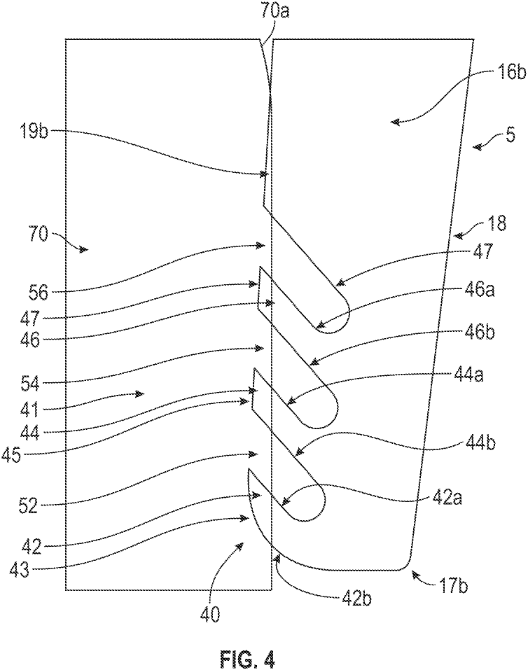

Referring now to FIGS. 3 and 4, the spaced apart ribs 40 define a plurality of sealing zones. For example, as shown in FIG. 4, a lower sealing zone 52 is defined by an upper surface 42a of the lower rib 42 and the lower surface 44b of the intermediate rib 44. An intermediate sealing zone 54 is defined between the upper surface 44a of the intermediate rib 44 and the lower surface 46b of the upper rib 46. An upper sealing zone 56 is defined between an upper surface 46a of the upper rib 46 and a lower surface 47 formed in the legs 16a, 16b. As illustrated, each of the sealing zones open in a secondary seal direction 8 that is generally opposite from the first/primary seal direction 7. As discussed in greater detail below, each of the ribs 40 is positioned to contact a mating surface 70a of a mating body 70 to prevent and/or otherwise resist reverse fluid flow in the direction of arrow 7.

With continued reference to FIGS. 3 and 4, the seal 5 is illustrated in-use and supported by and/or otherwise in contact with a hold down ring 21, which in operation, is used to prevent movement of the seal 5 in primarily the axial direction (i.e., in the direction of arrows 7 and 8) when exposed to sudden movements such as shock or vibration. In operation, the seal 5 forms a pressure-tight seal with surface 70a when inserted within the mating body 70, such as, for example, the seating surface of a ball valve. It should be understood that the mating body 70 can be, in addition to a ball valve, any other type of valve, a pump, a choke, and any other equipment that requires a surface to surface (e.g., metal-to-metal, etc.) seal with bi-directional sealing capability at high pressures, such as, for example, pressures over 2,000 psi. In use, the seal 5 isolates the volume of fluid in area 4 (typically the low pressure side) from the volume of fluid in area 6 (the high pressure side). In operation, fluid pressure acting on the seal 5 causes the legs 16a/16b and ribs 40 to sealingly engage the surface 70a of the mating body 70. As the pressure increases, the sealing engagement is increased. According to some embodiments the seal 5 is formed to withstand extreme operating pressures greater than 20,000 psi. For example, when pressure in the area 6 increases, a force is exerted on inner surface 18 of the legs 16a and 16b, which causes the legs 16a and 16b to expand radially in the direction of arrow 11, thereby increasing the contact force between the seal 5 and the mating body 70. Pressure within area 4 above the seal 5 also increases the sealing engagement, as the pressure will exert a force in the direction of arrow 7 and onto the main body 10, pressing the seal 5 more firmly into the mating body 70, thereby creating a bi-directional sealing capability. In this way a conventional unidirectional seal is converted to having bidirectional capability, which can fill existing unidirectional glands without changing them (i.e., so they are interchangeable).

With continued reference to FIGS. 3 and 4, a plurality of redundant sealing zones 52, 54, and 56 are illustrated. In the prior designs, if the seal between the seal body and the mating body 70 failed, the seal would fail completely. In operation, if the seal formed between the lower rib 42 and the mating body 70 fails, the lower sealing zone 52 will be exposed to the pressure below the seal 5 and the seal will be held by the intermediate rib 44. Similarly, should the seal provided by the contact between the intermediate rib 44 and the mating body 70 fail, the intermediate sealing zone 54 will be exposed and the seal will continue to be held by the upper rib 46.

In some embodiments, each of the ribs 40 are designed to withstand different pressures. In other embodiments, each of the ribs 40 are designed to withstand different temperatures. In still other embodiments, each of the ribs 40 are designed to withstand and be otherwise exposed to different chemical, oxidative, and/or reductive conditions. In this way, the operator can control the flow of the fluid and other material under the seal by, for example, having the failure of certain ribs expose outlets for the fluid to flow into that otherwise would not be available.

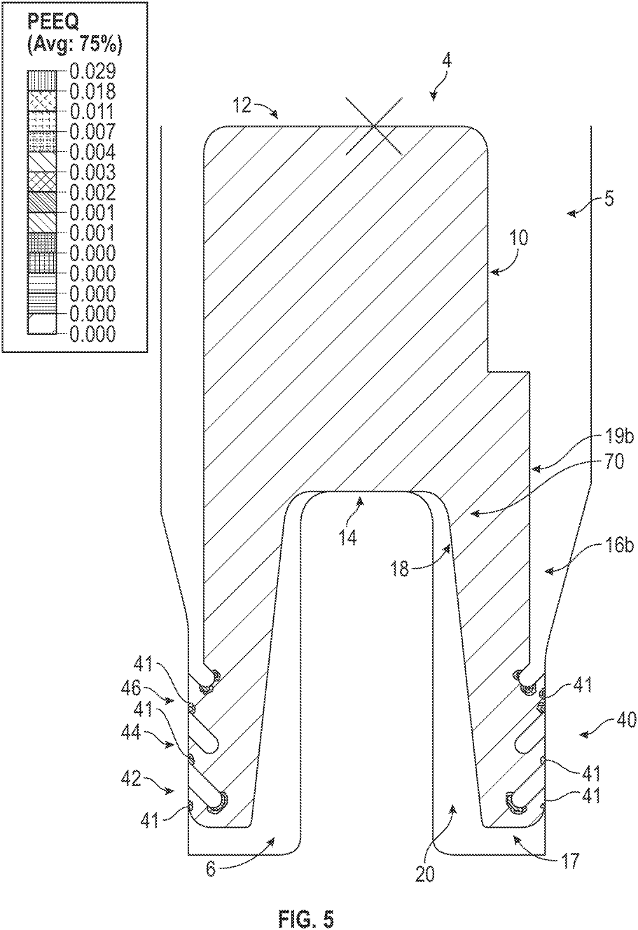

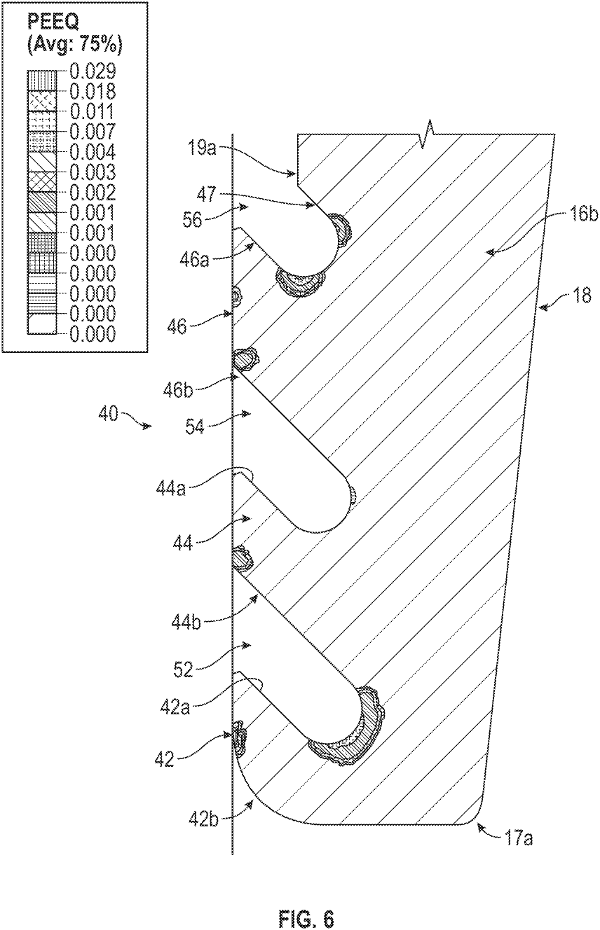

It should be understood that in certain embodiments, the shape of the ribs 42, 44, and 46 can increase the sealing performance with the mating body 70. For example, referring to FIGS. 5 and 6, the tips 41 of the ribs 43, 45, and 47 are shaped so that they maximize the possible contact surface with the mating body 70, increasing the likelihood of a strong seal. It should be understood that, although the illustrated embodiment shows the tips 41 of the ribs 43, 45, and 47 interfacing with a generally planar or otherwise flat mating body surface, in other embodiments, the seal 5 can be used in other applications such as, for example, curved surfaces of the mating body 70, such as in a ball valve. In some embodiments the tips are planar; however, the tips 41 may be otherwise formed, such as having a concave surface, a convex surface, a jagged surface having multiple peaks and valleys thereon. In other embodiments, the shape of the tips 41 may be flared outward with an increased thickness as the distance from the inner surface 18 increases. In yet other embodiments, the shape of the tips 41 may decrease in thickness as the distance from the inner surface 18 increases.

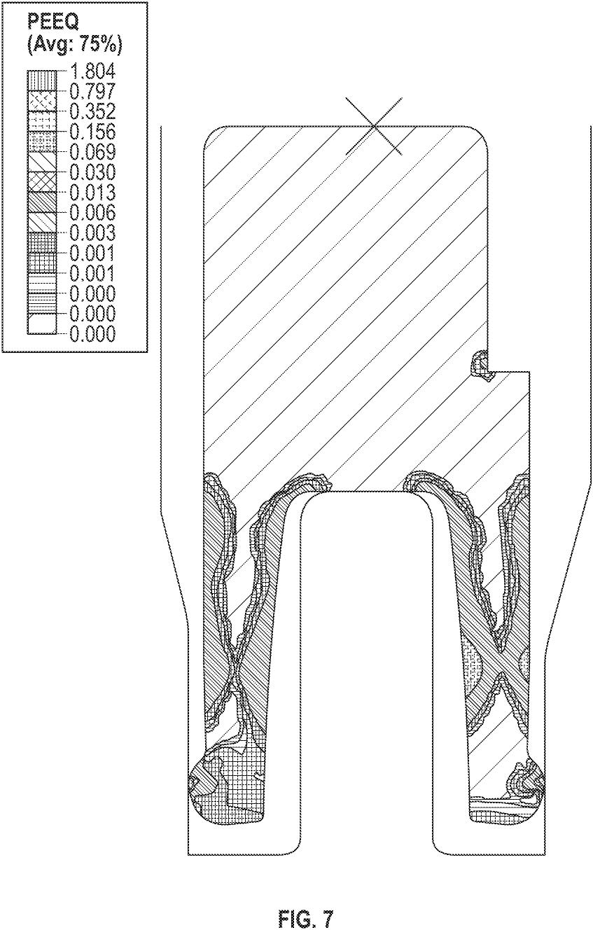

Comparing FIGS. 5 and 6 to FIG. 7, the results of a finite element analysis of the plastic strain present in the present seal 5 design (FIGS. 5 and 6) as compared to a unidirectional seal design (FIG. 7). During use, repeated exposure to plastic strain can fatigue material, causing it to mechanically fail, often catastrophically. The indicated figures are coded according to the scale with certain shades showing lower levels of plastic strain in the body and other shades indicating higher levels of plastic strain. In the unidirectional seal design, the plastic strain is distributed throughout the seal body, with the peak levels being observed at the contact points between the seal and the mating body 70. In contrast, the present design shows greatly reduced plastic strain overall, and the strain is limited to the ribs 42, 44, and 46 of the seal 5. These simulations indicate that the present bidirectional seal design is much less likely to mechanically fail due to material fatigue.

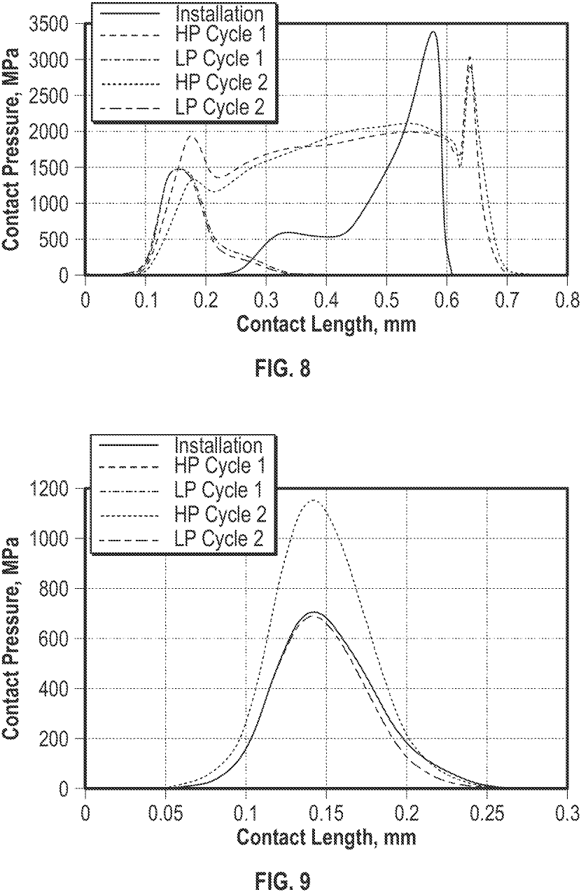

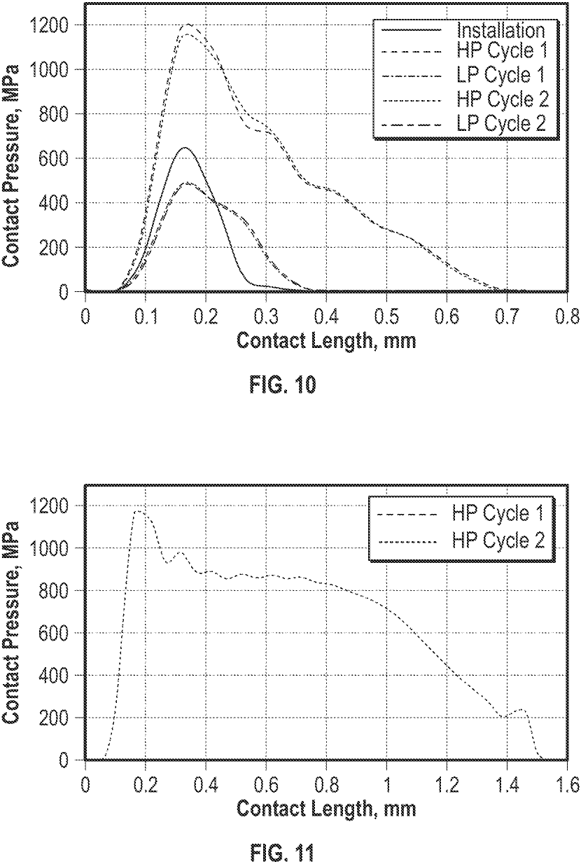

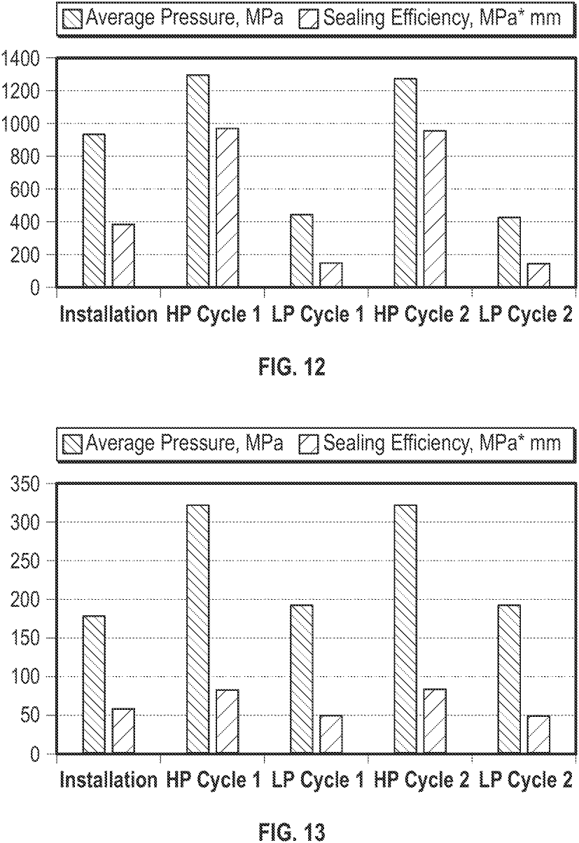

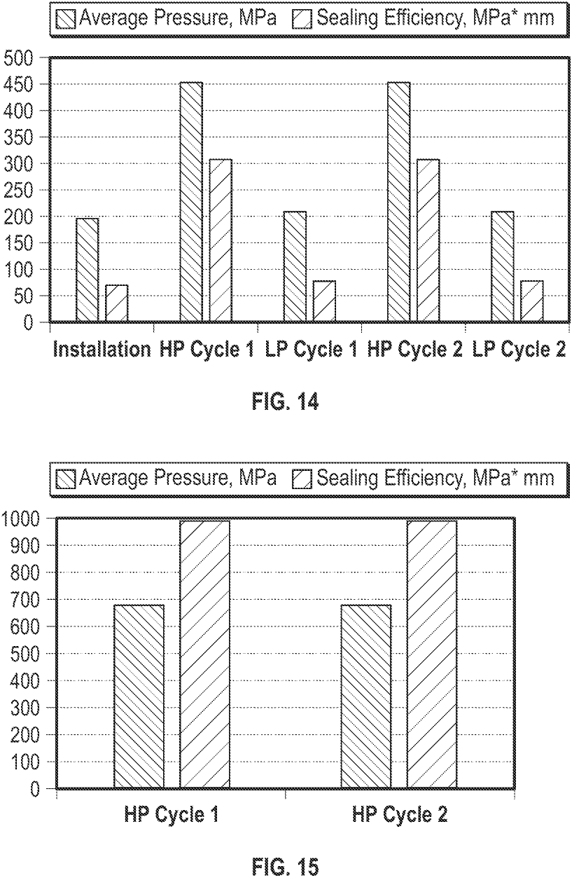

FIGS. 8-11 illustrate the contact pressure versus the contact length of a unidirectional seal (FIG. 8), the lower rib 42 (FIG. 9), the intermediate rib 44 (FIG. 10), and the upper rib 46 (FIG. 10) as calculated by a finite element analysis for the installation, two high pressure cycles, and two low pressure cycles. Additionally, the average pressure and sealing efficiency of a unidirectional seal, the lower rib 42, the intermediate rib 44, and the upper rib 46 as calculated by a finite element analysis for the installation, two high pressure cycles, and two low pressure cycles are shown in FIGS. 12-15. Close examination of these figures shows that the bidirectional seal design is calculated to have triple the sealing performance at high pressures and double the sealing the performance at low pressures versus the unidirectional seal design.

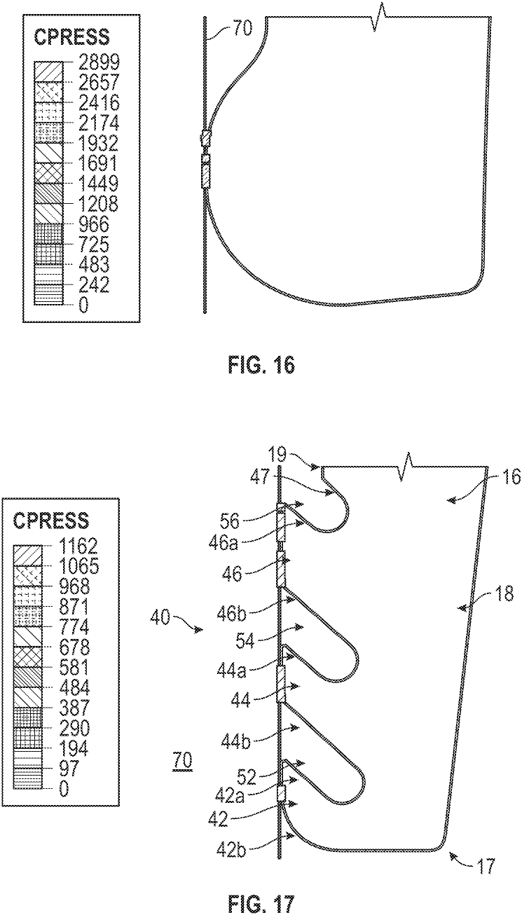

FIGS. 16 and 17 illustrate the contact pressure of a unidirectional seal against a mating body 70 (FIG. 16) and of the bidirectional seal 5 against the mating body 70 (FIG. 17) as calculated by a finite element analysis for a low pressure cycle. Comparison of these figures illustrate that the bidirectional seal design 5 is calculated to have double the sealing area over the unidirectional seal design.

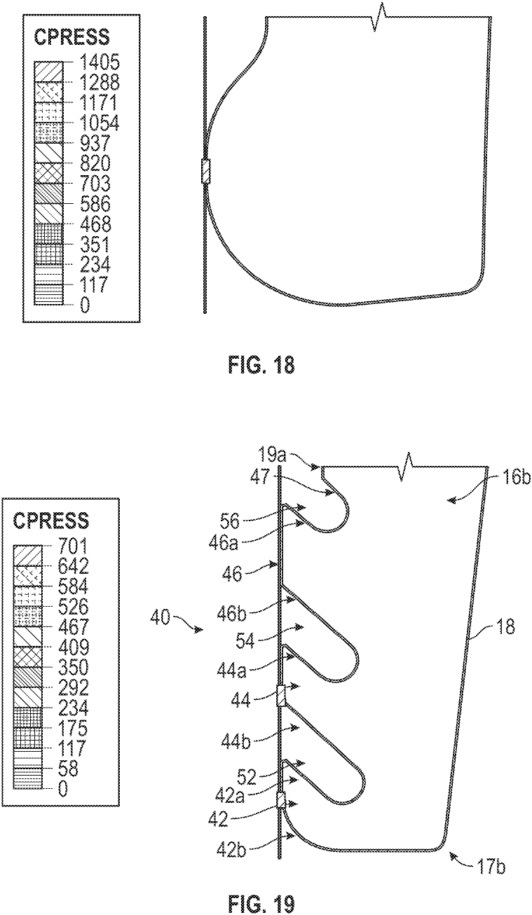

Similarly, FIGS. 18 and 19 illustrate the contact pressure of a unidirectional seal against a mating body (FIG. 18) and of the bidirectional seal 5 against the mating body 70 (FIG. 19) as calculated by a finite element analysis for a high pressure cycle. Comparison of these figures shows that the novel bidirectional seal design is calculated to have double the sealing area over the unidirectional seal design in this case as well.

In some embodiments, the seal 5 is formed from a polytetrafluoroethylene-based (PTFE) material. In other embodiments, the seal 5 is formed of a polyether ether ketone-based (PEEK) material. In still other embodiments, the seal 5 is formed of an elastic polymer material such as, but not limited to, rubber. However, it should be understood that other materials may be utilized, including combinations thereof, depending on the particular application,.

In alternative embodiments, the seal 5 may be formed of metal such as, but not limited to, copper, aluminum, silver, gold, indium, lead, tin, nickel, tungsten, molybdenum, iron, or other metals. In other embodiments, the seal is formed of an alloy of metal such as, but not limited to, nickel-copper alloys, carbon steels, stainless steels, chromium steels, high-nickel chromium steels, nickel-chromium alloys, nickel-molybdenum-chromium alloys, nickel-chromium-cobalt alloys, cobalt-chromium-nickel alloys, cobalt-nickel-chromium-tungsten alloys, nickel-chromium-tungsten-molybdenum alloys, nickel-chromium-aluminum-iron alloys, nickel-chromium-cobalt alloys, depending on the temperature, pressure, chemical resistance, and oxidation or reduction resistance demands of the sealing environment.

In some embodiments, to provide additional chemical, oxidation, or reduction resistance, the seal surfaces may be coated with materials such as, but not limited to, gold, silver, PTFE, copper, lead, indium, nickel, or aluminum.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose.

In the specification and claims, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s), as defined solely by the appended claims. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A pressure-energized bidirectional seal, comprising:
a main body having a first end and a second end;
a pair of legs extending from the second end of the main body, the pair of legs having an inner surface and an outer surface, the inner surface forming a hollow interior opening in a first direction; and
at least one rib extending from the outer surfaces and forming a sealing zone opening in a second and generally opposite direction from the first direction, the at least one rib configured to sealingly engage a mating surface of a mating body.

2. The seal of claim 1, wherein the at least one rib extends toward the first end.

3. The seal of claim 1, wherein the at least one rib is formed having a tip to sealingly engage the mating surface, the tip having a planar surface.

4. The seal of claim 1, wherein the at least one rib comprises three spaced apart ribs extending from the outer surfaces to sealingly engage the mating surface.

5. The seal of claim 4, wherein the three spaced apart ribs form spaced apart sealing zones therebetween opening in the second direction.

6. The seal of claim 1, wherein the seal is formed of a non-metallic material.

7. The seal of claim 1, wherein the seal is formed of a polytetrafluoroethylene-based (PTFE) material, a polyether ether ketone-based (PEEK) material, or an elastic polymer material.

8. The seal of claim 1, wherein the seal is formed of nickel-copper alloys, carbon steels, stainless steels, chromium steels, high-nickel chromium steels, nickel-chromium alloys, nickel-molybdenum-chromium alloys, nickel-chromium-cobalt alloys, cobalt-chromium-nickel alloys, cobalt-nickel-chromium-tungsten alloys, nickel-chromium-tungsten-molybdenum alloys, nickel-chromium-aluminum-iron alloys, or nickel-chromium-cobalt alloys.

9. The seal of claim 1, wherein the main body of the seal is formed of a first material and the legs are formed of a second and different material.

10. The seal of claim 1, wherein the main body and legs are formed of a first material and the plurality of ribs are formed of a second material.

11. The seal of claim 1, wherein the at least one rib comprises three spaced apart ribs extending from the outer surfaces to sealingly engage the mating surface, at least one of the ribs formed of a material different from the other ribs.

12. The seal of claim 1, further comprising a coating covering at least a portion of the at least one rib.

13. A bidirectional pressure-energized seal comprising:
a main body formed having a first upper surface and an opposed bottom second surface, an inner and an outer sidewall extending between the first and second surfaces;
an inner leg and an outer leg extending from the second surface, the inner and outer legs having an outer surface and an inner surface, the inner surfaces forming a hollow interior opening in a first direction; and
a plurality of spaced apart ribs extending from the outer leg outer surface and sized to sealingly engage a surface of a mating body, at least one of the plurality of ribs angularly extending toward the upper surface of the main body and forming a sealing zone opening in a second direction generally opposite to the first direction.

14. The bidirectional pressure-energized seal of claim 13 wherein the seal is formed of a polytetrafluoroethylene-based (PTFE) material, a polyether ether ketone-based (PEEK) material, or an elastic polymer material.

15. The bidirectional pressure-energized seal of claim 13 wherein the seal is formed of nickel-copper alloys, carbon steels, stainless steels, chromium steels, high-nickel chromium steels, nickel-chromium alloys, nickel-molybdenum-chromium alloys, nickel-chromium-cobalt alloys, cobalt-chromium-nickel alloys, cobalt-nickel-chromium-tungsten alloys, nickel-chromium-tungsten-molybdenum alloys, nickel-chromium-aluminum-iron alloys, or nickel-chromium-cobalt alloys.

16. The bidirectional pressure-energized seal of claim 13 wherein the plurality of ribs are formed having a planar end surface to sealingly engage the mating surface.

17. The bidirectional pressure-energized seal of claim 13 wherein the plurality of ribs comprises three ribs.

18. The bidirectional pressure-energized seal of claim 13 further comprising a coating disposed over the plurality of ribs.

19. The bidirectional pressure-energized seal of claim 13 wherein each rib of the plurality of ribs is of a constant thickness.

20. A method of installing a bidirectional pressure-energized seal, the method comprising:
providing a bi-directional pressure-energized seal having a main body having a first upper surface and a second lower surface and a pair of legs extending from the second surface of the main body, the legs having an inner surface and an outer surface, the inner surface form a hollow interior opening into a first direction, and further including a plurality ribs extending from the outer surface in a direction toward the first upper surface, the plurality of ribs forming sealing zones opening in a second direction generally opposite the first direction;
providing a fluid conduit with an outer surface;
providing a valve, the valve being configured to receive a portion of the fluid conduit and having a mating surface for engaging a seal;
seating the bidirectional seal on the outer surface of the fluid conduit; and
inserting a portion of the fluid conduit into the valve such that the bidirectional seal sealingly engages the mating surface of the valve.
